(19) United States
(12) Patent Application Publication
(10) Pub. No.: US 2010/0213093 A1
(43) Pub. Date: Aug. 26, 2010

(54) Product Assembly

(75) Inventors: Yoshio Iwasaki, Shiga (JP); Akira Yamamoto, Shiga (JP)

Correspondence Address: Hogan Lovells US LLP, 1999 AVENUE OF THE STARS, SUITE 1400, LOS ANGELES, CA, 90067, US

(73) Assignee: ISHIDA CO., LTD., Kyoto-shi, Kyoto (JP)

(21) Appl. No.: 12/600,229

(22) PCT Filed: Mar. 26, 2008
(86) PCT No.: PCT/JP2008/055711

§ 371 Date: Nov. 13, 2009

(30) Foreign Application Priority Data
May 29, 2007 (JP) 2007-141675

(51) Int. Cl. B65D 73/00; B32B 38/14

(52) U.S. Cl. 206/466; 156/277

(57) ABSTRACT

[Problem to be Solved] To provide a product assembly including a display strip and product-enclosed bags attached to the display strip, to which the product enclosed bag once detached can be reattached in spite of the fact that the display strip is of a heat sealing type and which can make customers recognize that the product-enclosed bag once detached can be reattached to the display strip.

[Solution] The product assembly includes product-enclosed bags attached to a display strip 100 by thermal compression bonding at attaching sites 114, wherein the display strip 100 comprises a low-melting-point polymer layer 111, an adhesive layer 112, and a substrate layer. In the product assembly, the low-melting-point polymer layer 111 is transparent and the color of the adhesive layer 112 at the attaching sites 114 is different from that of the adhesive layer 112 at other sites, or the low-melting-point polymer layer 111 and the adhesive layer 112 are both transparent and the color of the substrate layer in a region including at least the attaching site 114, within regions where the adhesive layer 112 is exposed by detaching the product-enclosed bags, is different from that of the substrate layer at other sites.

### TECHNICAL FIELD

The present invention relates to a product assembly using a display strip for arranging and displaying a plurality of product-enclosed bags by attaching the bags thereto, and in particular, the present invention relates to a product assembly to which a product-enclosed bag once detached can be reattached in spite of the fact that a heat bonding type display strip is used.

### BACKGROUND ART

As a method for displaying products such as snack foods packaged in bags by packaging machines for sale, one called “strip pack display” requiring no display rack is known.

The strip pack display is a display form achieved by a product assembly in which a plurality of product-enclosed bags are attached and suspended to a tape material with a certain width, called “display strip”.

As a display strip for use in such strip pack display, one having a heat sealable layer on one surface thereof has been proposed, to which product-enclosed bags can be directly bonded by heat sealing. Use of such a display strip makes it very easy to automate a continuous process including steps of enclosing products in bags and attaching the product-enclosed bags to the display strip.

Further, another display strip is also known, in which an adhesive layer is provided between a heat sealable layer and a substrate layer or as part of the heat sealable layer on the inner side of the heat sealable layer so as to come in contact with the substrate layer (see Patent Document 1). The adhesive layer provided in such a manner as described above is not exposed until a product-enclosed bag attached to the heat sealable layer is detached from the display strip. The adhesive layer is exposed by detaching a product-enclosed bag from the display strip, which has an advantage that when canceling the purchase of a product once detached from the display strip, the product-enclosed bags can be reattached to the display strip. In such a display strip, the adhesive layer has not only the function of allowing product-enclosed bags to be reattached to the display strip but also the function of bonding the heat sealable layer and the substrate layer.

Patent Document 1: WO 2004/054895

### DISCLOSURE OF THE INVENTION

### Problem to be Solved by the Invention

In order to take advantage of a product assembly using the display strip disclosed in Patent Document 1, it is necessary to make customers, who have detached a product from the product assembly, recognize that the product once detached can be reattached to the product assembly at a predetermined position. Therefore, the product assembly preferably has the function of reminding customers of the presence of such a predetermined position.

according to the technique disclosed in Patent Document 1, the heat sealable layer, including an attaching site and its vicinity, is peeled off from the display strip by detaching a product-enclosed bag from the display strip, being stuck to the detached product-enclosed bag. From this situation, it can be expected that it becomes possible to remind customers that a product-enclosed bag once detached can be reattached to the product assembly by, for example, making the heat sealable layer of the display strip opaque. This is because when the adhesive layer, which is exposed by peeling off the heat sealable layer, is fully colored with a color different from that of the heat sealable layer or, when the adhesive layer is transparent or translucent and the substrate layer is fully colored with a color different from that of the heat sealable layer, an unexposed portion of the adhesive layer or the substrate layer can be concealed by the opaque heat sealable layer so that when a product-enclosed bag is detached from the display strip, only the exposed portion of the adhesive layer shows a different color.

However, as described above, since the heat sealable layer peeled off from the display strip disclosed in Patent Document 1 by detaching a product-enclosed bag is stuck to the detached product-enclosed bag, the heat sealable layer stuck to the product-enclosed bag is preferably as unnoticeable as possible and is therefore required to be transparent. For this reason, the above-described method in which an unexposed portion of the adhesive layer or the substrate layer is concealed by making the sealant layer opaque is unlikely to be commercially acceptable.

### Means for Solving the Problems

In order to solve the above problem, the present invention is directed to a product assembly with product-enclosed bags attached to a display strip comprising a sealant layer and a substrate layer,

wherein said sealant layer has an outer layer including a low-melting-point polymer layer, to which said product-enclosed bags are attachable by heat fusion, and an inner layer including an adhesive layer, to which said product-enclosed bags are reattachable, and

said product-enclosed bags are attached to said display strip by thermal compression bonding at attaching sites.

The present invention is mainly characterized in that said low-melting-point polymer layer is transparent and a color of said adhesive layer at the attaching sites is different from that of said adhesive layer at other sites, or in that said low-melting-point polymer layer and said adhesive layer are both transparent, and a color of said substrate layer in a region including at least said attaching site, within regions where said adhesive layer is exposed by detaching said product-enclosed bags, is different from that of said substrate layer at other sites.

### EFFECT OF THE INVENTION

According to the present invention, it is possible to provide a product assembly whose system for allowing a product-enclosed bag once detached to be reattached to a display strip thereof can be effectively utilized. This is because when detaching a product-enclosed bag from the display strip used in the product assembly according to the present invention, customers can easily become aware that the color of only the attaching site where the adhesive layer is exposed or the color of only a site, including the attaching site, where the adhesive layer is exposed is different from that of other sites, and therefore the customers can recognize that the product-enclosed bag once taken in hand can be reattached to the display strip.

### BRIEF DESCRIPTION OF THE DRAWINGS

FIG. 1 is a schematic view showing a product assembly according to the present invention displayed in the form of strip bag display.

FIG. 2A is a schematic front view of a display strip to be used in the present invention.

FIG. 2B is a schematic front view of a display strip to be used in the present invention, which is different from that shown in FIG. 2A.

FIG. 3 is a schematic view illustrating a process for attaching product-enclosed bags to a display strip.

### DESCRIPTION OF THF REFERENCE NUMERALS

100 display strip
101 main body
102 hole punch portion
111 low-melting-point polymer layer
112 adhesive layer
113 slit
114 attaching site
115 eye mark
200 product-enclosed bag
300 product assembly
H hook (fixture)

### BEST MODE FOR CARRYING OUT THE INVENTION

### Basic Structure of Product Assembly

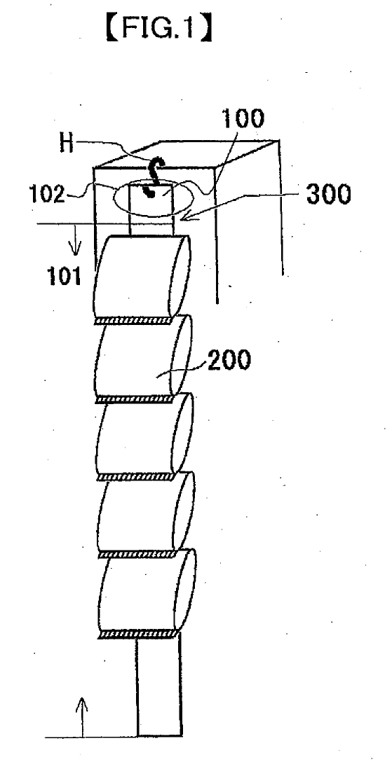

FIG. 1 is a schematic view showing a display strip 100 and product-enclosed bags 200 constituting a product assembly 300 according to the present invention. As shown in FIG. 1, the display strip 100 includes at least a main body 101 to which the product-enclosed bags 200 are attached. In the aspect shown in FIG. 1, the display strip 100 further includes a hole punch portion 102 having a punched hole for suspending. The hole punch portion 102 is a portion for use in fixing the display strip 100 to a display rack or the like with the use of, for example, a hook H, and therefore as shown in FIG. 1, the hole punch portion 102 is provided on the upper side of the main body 101 with respect to a positional relationship when the display strip is displayed in the form of strip pack display.

The display strip 100 is configured to allow the product-enclosed bags to be attached to the surface thereof by fusion bonding, and therefore has a basic structure in which a sealant layer, to which the product-enclosed bags are attached, is provided on the outer surface side thereof and a substrate layer is provided on the inner side (back side) of the sealant layer.

The sealant layer of the display strip 100 has a low-melting-point polymer layer 111 and an adhesive layer 112 so that the product-enclosed bags 200 can be reattached to the display strip 100. The low-melting-point polymer layer 111 is provided on the outer surface side and the adhesive layer 112 is provided on the inner surface side, on the substrate layer side.

It is to be noted that the adhesive layer 112 does not always need to be in direct contact with the substrate layer. For example, an intermediate layer, an anchor coat layer, reinforcing layer and the like may be provided between the adhesive layer 112 and the substrate layer.

In order to remind customers that the product-enclosed bag 200 once taken in hand can be reattached to the display strip 100, the product assembly 300 according to the present invention is configured to allow the color of at least part of a site, to which the adhesive layer 112 is exposed by detaching the product-enclosed bag 200 so that the product-enclosed bag 200 can be reattached, to be made different from that of other sites. Examples of a method for making a difference between a site, to which the product-enclosed bag 200 can be reattached, and other sites include: (1) a method in which the low-melting-point polymer layer 111 that is transparent is used and the color of the adhesive layer 112 at attaching sites for the product-enclosed bags 200 is made different from that of the adhesive layer at other sites; and (2) a method in which the low-melting-point polymer layer 111 and the adhesive layer 112 that are transparent are used and the color of the substrate layer in a region including the attaching site, within regions where the adhesive layer 112 is exposed by detaching the product-enclosed bags 100, is made different from that of the substrate layer at other sites.

(Sealant Layer)

<Low-Melting-Point Polymer Layer>

A low-melting-point polymer for use in the low-melting-point polymer layer 111 provided as an outer layer of the sealant layer is melted at a temperature as low as 160° C. or less, preferably 120° C. or less, has no adhesion at a room temperature, and exhibits sufficient fusion bondability. Preferred specific examples of such a low-melting-point polymer include polypropylene, copolymers of propylene and other olefins (e.g., ethylene, α-olefins having 4 to 12 carbon atoms), low-density polyethylene (including metallocene linear low-density polyethylene), ethylene-vinyl acetate copolymer, ethylene-methacrylic acid ester copolymer, and the like. The sealant layer may have either a single-layer structure or a multilayer structure having two or more layers.

According to the present invention, the color of low-melting-point polymer layer 111 is transparent. This is because when the product-enclosed bag 200 is detached, part of the low-melting-point polymer layer 111 of the display strip 100 is peeled off from the display strip 100 and stuck to the detached product-enclosed bag, and therefore the low-melting-point polymer layer 111 is required to be as unnoticeable as possible from the commercial standpoint.

<Slit>

The low-melting-point polymer layer 111 preferably has slits 113 near each site, to which the product-enclosed bag is bonded, so that when the product-enclosed bag 200 fusion-bonded to the low-melting-point polymer layer 111 is detached, the low-melting-point polymer layer 111 is reliably broken to expose the adhesive layer 112. The interval between the slits 113 is not particularly limited, but it is preferred that the interval between the slits 113 is appropriately selected from the range of 1 to 10 mm according to the size, purpose of use, etc. of the display strip.

The slits 113 are provided to divide the low-melting-point polymer layer 111 into small regions, and serve as boundaries between the regions to help only a desired region of the low-melting-point polymer layer 111 including an attaching site 114, at which the product-enclosed bag 200 is fusion-bonded to the display strip 100, to be reliably peeled off from the display strip 100. Therefore, the slits 113 are preferably formed linearly along the longitudinal direction and/or in a crossing direction to the length direction of the product-enclosed bag. The slits 113 may be formed in, for example, a zigzag pattern, but in this case, there is a possibility that cracks will occur from the edges of the zigzag pattern in parts other than the low-melting-point polymer layer 111.

The form of the low-melting-point polymer layer 111 is not particularly limited, and can be appropriately selected according to the weight of a product enclosed in a bag to be attached to the display strip 100. The slits 113 can be easily formed by a continuous-cut line or by perforations.

The depth of the slits 113 is preferably controlled so that the slits 113 penetrate the low-melting-point polymer layer 111 and reach but do not penetrate the adhesive layer 112. More preferably, in a case where the adhesive layer 112 has a thickness of, for example, 20 μm, the depth of the slits 113 is controlled so that the slits 113 penetrate the low-melting-point polymer layer 111 and reach a depth of less than 5 μm, which is a quarter of the depth of the adhesive layer 112. Most preferably, the lower ends of the slits 113 are located just at the interface between the low-melting-point polymer layer 111 and the adhesive layer 112. If the depth of the slits 113 is not sufficient, that is, if the slits 113 do not penetrate the low-melting-point polymer layer 111 and therefore the low-melting-point polymer layer 111 is substantially continuous, the low-melting-point polymer layer 111 cannot be peeled off along the slits 113 when the product-enclosed bag is detached. In this case, there is a possibility that the entire low-melting-point polymer layer 111 located on the lower side of the slit 113 will be peeled off. On the other hand, if the slits 113 penetrate the adhesive layer 112 and reach the substrate layer, there is a possibility that the display strip 100 itself will be broken.

In this way, by controlling the depth of the slits 113, it is possible to peel off only a desired region of the low-melting-point polymer layer 111 divided by the slits 113 as boundaries while the adhesive layer 112 is reliably left in the side of the display strip 100. A method for forming the slits 113 is not particularly limited, but the slits 113 are preferably formed by a Thomson blade, laser processing, or a die cutting roll to accurately control the depth of the slits 113.

<Adhesive Layer>

The adhesive layer 112 provided as an inner layer of the sealant layer contains adhesives exhibiting adhesion at a room temperature. The adhesives are not particularly limited as long as they exhibit adhesion at a room temperature, but are preferably rubber-based adhesives or acrylic adhesives.

The thickness of the adhesive layer 112 is not particularly limited, but the lower limit thereof is preferably 10 μm, and the upper limit thereof is preferably 300 μm. If the thickness thereof is less than 10 μm, there is a case where the adhesive layer 112 is peeled off together with the sealant layer when the product-enclosed bag once attached is detached, which makes it impossible to reattach the product-enclosed bag 200. On the other hand, if the thickness thereof exceeds 300 μm, the adhesive strength thereof is too strong, and therefore it is hard to detach the product-enclosed bag 200 once attached.

<Printing on Adhesive Layer>

In order to make the color of the adhesive layer 112 at the attaching sites different from that of the adhesive layer at other sites, the adhesive layer 112 of the product assembly according to the present invention is preferably laminated by using adhesives containing a heat-sensitive ink or a pressure-sensitive ink. The adhesive layer 112 containing a heat-sensitive ink or a pressure-sensitive ink makes it possible to easily make the color only at the attaching sites different from that at other sites when the product-enclosed bags 200 are attached to the display strip 100 at the attaching sites 114 by thermal compression bonding.

Examples of such a heat-sensitive ink or a pressure-sensitive ink to be used include well-known heat-sensitive inks whose colors become visible or invisible or change at a temperature or pressure above a certain level and which maintain their colors once changed by coloring, decoloring, or discoloring even after the temperature or pressure falls below the certain level. Specific examples thereof include an ink described in Patent Document 2 which contains microcapsule particles and an ink described in Patent Document 3 which contains a leuco dye and a color developer or a decolorizer. Alternatively, a mixture of a heat-sensitive ink and a pressure-sensitive ink may be used.

Patent Document 2: JP-A No. 2001-335729

Patent Document 3: JP-A No. 2003-313453

In the adhesive layer 112 containing a heat-sensitive ink or a pressure-sensitive ink, heat or pressure is applied specifically only to the attaching sites 114 when the product-enclosed bags are thermally compression-bonded to the display-strip 100. By utilizing this heat or pressure, it is possible to easily obtain a produce assembly 300 in which the color of only the attaching sites 114 is different from that of other sites without using a complicated method in which a colored ink is applied only to predetermined portions of the adhesive layer.

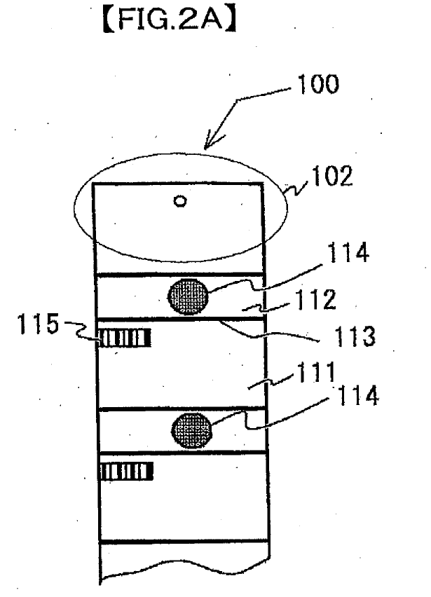

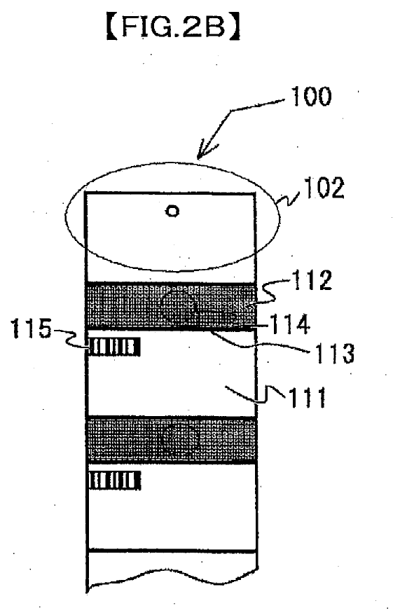

FIG. 2A is a schematic view of the display strip 100 in which the adhesive layer 112 is colored. In FIG. 2A, patterned portions represent colored portions. In the aspect shown in FIG. 2B, only the attaching sites 114, to which the product-enclosed bags 200 are attached, are colored.

<Intermediate Layer>

The substrate layer and the adhesive layer 112 are preferably laminated with an intermediate layer made of polyethylene interposed therebetween. Since polyethylene is flexible and has a high tensile elongation, the strength of the entire display strip 100 or a hole punch strength can be improved by providing the intermediate layer made of polyethylene.

The intermediate layer made of polyethylene provided between the substrate layer and the adhesive layer 112 can be laminated by extrusion-molding polyethylene. It is to be noted that an ethylene-(meth) acrylic acid copolymer or an ionomer of the ethylene-(meth)acrylic acid copolymer may be used instead of polyethylene.

The thickness of the polyethylene layer is not particularly limited, but the lower limit thereof is preferably 5 μm, and the upper limit thereof is preferably 50 μm. If the thickness thereof is less than 5 μm, there is a case where the effect of improving strength cannot be sufficiently obtained. On the other hand, if the thickness thereof exceeds 50 μm, there is a case where the total thickness of the display strip 100 becomes large, thereby impairing heat-sealability due to heat insulating effect.

<Anchor Coat Layer>

Further, an anchor coat layer is preferably provided between the substrate layer and the adhesive layer 112. This improves bond strength between the substrate layer and the adhesive layer 112 so that delamination between the substrate layer and the adhesive layer 112 is less likely to occur. Such an anchor coat layer is not particularly limited, and examples thereof include those made of conventionally-known anchor coating agents such as polyisocyanate/polyester-based two-pack curable adhesives and the like. With such anchor coating agent, the anchor coat layer is formed by coating the surface of a resin film, on which adhesives are applied.

As necessary, the sealant layer may contain additives usually used such as waxes, UV blocking agents, antioxidants, plasticizers, lubricants, pigments, dyes and the like.

<Substrate Layer>

The display strip employed in the present invention suspends many product-enclosed bags 200 being attached thereto, and therefore the substrate layer of the display strip includes paper and/or a stretched film to provide sufficient strength and heat resistance so as not to be melted or deteriorated during fusion bonding.

The stretched film is not particularly limited, and preferred examples thereof include a film made of biaxial oriented polypropylene (OPP) and a film made of biaxial oriented polyethylene terephthalate. These films may be used as a single layer or a lamination of two or more of them.

The thickness of the substrate layer is not particularly limited, but the lower limit thereof is preferably 30 μm, and the upper limit thereof is preferably 500 μm. If the thickness thereof is less than 30 μm, there is a case where a sufficient hole punch strength cannot be obtained, and therefore the substrate layer is broken during display or when the product-enclosed bag is detached. On the other hand, if the thickness thereof exceeds 500 μm, there is a case where the substrate layer functions as a heat insulating material and therefore heat is not sufficiently transmitted to the low-melting-point polymer layer 111 of the sealant layer during fusion bonding.

<Eye Mark>

In a case where the substrate layer of the display strip 100 according to the present invention is colored only at predetermined sites with a color different from that of the substrate layer at other sites, eye marks 115 are preferably provided in advance on a film constituting the substrate layer.

This eye mark 115 plays a role in accurately indicating a position at which printing is performed on the substrate layer of the display strip 100 and a position at which the product-enclosed bag 200 is attached to the display strip 100.

<Printing on Substrate Layer>

In a case where the adhesive layer 112 itself of the product assembly 300 according to the present invention is transparent and is not colored, the color of the substrate layer in a region including at least the attaching site 114, within regions where the adhesive layer 112 is exposed by detaching the product-enclosed bags 200, can be made different from that of the substrate layer in other regions.

In a case where the display strip 100 has the above-described slits, the attaching site 114 and the region where the adhesive layer 112 is exposed by detaching the product-enclosed bag 200 are not always the same. Therefore, unlike a case where the adhesive layer 112 is colored, the substrate layer can be colored not only at the attaching sites 114 but also in part or all of the regions where the adhesive layer 112 is exposed. This is because the coloring of the substrate layer is performed not by utilizing heat generated by thermal compression bonding between the display strip 100 and the product-enclosed bag 200 but by, for example, previous printing under the control of the eye marks 115. Further, by coloring the substrate layer not only at the attaching sites 114 but also in part or all of the regions where the adhesive layer 112 is exposed or in regions where the adhesive layer 112 is not exposed, it is possible to effectively appeal to customers.

FIG. 2B, is a schematic view of the display strip 100 in which the substrate layer is colored. The patterned portions represent colored portions. In FIG. 2B, the colored substrate layer can be seen through the transparent adhesive layer 112. Further, in the aspect shown in FIG. 2B, the substrate layer is fully colored in all regions where the adhesive layer 112 is exposed by detaching the product-enclosed bags 200.

Examples of a method for coloring only the predetermined region of the substrate layer include well-known printing methods such as a screen printing method and the like. In a case where the substrate layer is formed from a material having an absorbing surface such as paper and the like, the printing of the predetermined region of the substrate layer can be performed by ink-jet printing and the like.

(Form of Display Strip)

The form of the display strip 100 according to the present invention is not particularly limited, and examples thereof include tapes and sheets and the like.

As shown in FIG. 1, in a case where the display strip 100 according to the present invention has the hole punch portion 102 having a punched hole for suspending, the product assembly is usually displayed by suspending it on the fixture H such as a hook.

It is to be noted that the hole punch portion 102 having a punched hole is preferably provided only at the upper side of the main body 101. If the hole punch portion 102 is also provided at the lower side of the main body 101, there is a case where the product assembly is suspended upside down at stores and the like.

(Method for Producing Display Strip)

The heat-sealing type display strip 100, to which the product-enclosed bags 200 can be reattached, can be produced by a well-known method. More specifically, adhesives are applied onto an anchor coat layer provided on a substrate layer to form an adhesive layer. Then, a low-melting-point polymer layer is laminated on the adhesive layer by a well-known method to obtain a display strip to which product-enclosed bags can be reattached.

Further, in order to use the thus obtained display strip as the display strip 100 for using the product assembly 300 according to the present invention, it is necessary to color only the predetermined region of the adhesive layer 112 or the substrate layer with a color different from that of the adhesive layer 112 or the substrate layer at other sites by a method which will be described later.

(Product-Enclosed Bag)

As a material for the product-enclosed bags 200, which is attached to the product assembly according to the present invention, any materials generally used as packaging films can be used. Examples thereof include bags, whose surface is made of a biaxial oriented polymer, such as a bag composed of biaxial oriented polypropylene (OPP) layer/print layer/polyethylene (PE) layer/aluminum vapor-deposited polyethylene terephthalate (PET) layer/polyethylene (PE) layer/non-oriented polypropylene (CPP) layer and a bag composed of transparent vapor deposited-biaxial oriented polyethylene terephthalate (PET) layer/print layer/non-oriented polypropylene (CPP) layer, a bag having a heat-sealable sealant layer as an outermost layer, and the like. Examples of such a bag having a heat-sealable sealant layer as an outermost layer include those composed of heat-sealable biaxial oriented polypropylene (OPH) layer/print layer/polyethylene (PE) layer/aluminum vapor-deposited heat-sealable biaxial oriented polypropylene (OPH) layer, which is used in the U.S. Such product-enclosed bags 200 can be appropriately attached to the display strip 100 according to the present invention.

(Production of Product-Enclosed Bag)

The product-enclosed, bags 200 themselves are those generally used, and therefore can be produced by a well-known production method. One example of such a production method is as follows.

First, a packaging film is supplied to a packaging machine. While the supplied packaging film is transferred from a shoulder to a former of the packaging machine, the packaging film is formed into a tubular form. Then, the both longitudinal ends of the packaging film are joined together and longitudinally sealed, and then the tubular-shaped film is transversely sealed at predetermined intervals and cut to form individual product-enclosed bags 200.

(Method for Producing Product Assembly)

An example of an apparatus for attaching the product-enclosed bags 200 to the display strip 100 to produce a product assembly according to the present invention described in, for example, Patent Document 4. More specifically, while the display strip 100 fed from a supply roll is supplied to an attaching apparatus, the eye marks 115 of the display strip 100 are detected by a detection sensor. When a signal detected from the eye mark 115 is sent to a control unit of the attaching apparatus, the control unit controls the motion of an arm for catching the product-enclosed bag 200 so that an attaching site of the product-enclosed bag 200 reaches a heater surface of the attaching apparatus in accordance with the timing when the predetermined attaching site 114 of the display strip 100 reaches the heater surface. In addition, the control unit also controls the timing when a pressing body reaches the heater surface to press, on the heater surface, the product-enclosed bag 200 against the display strip 100 at a predetermined site.

As described above, a product assembly 300 having the product-enclosed bags 200 attached thereto is produced by pressing each of the product-enclosed bags 200 against the display strip 100 at a predetermined site.

Patent Document 4: JP-A No. 2004-90949

In the case of the product assembly 300 according to the aspect (1) of the present invention in which the color of the adhesive layer at the attaching sites is different from that of the adhesive layer at other sites, the use of the above-described adhesives containing at least one of a heat-sensitive ink and a pressure-sensitive ink makes it possible to automatically make the color of the adhesive layer only at the attaching sites different from that of the adhesive layer at other sites in a step of attaching the product-enclosed bags 200 to the display strip 100 by thermal compression bonding.

On the other hand, the product assembly 300 according to the aspect (2) of the present invention, in which the color of the substrate layer in a region including at least the attaching site, within regions where the adhesive layer 112 is exposed by detaching the product-enclosed bags 200, is different from that of the substrate layer at other sites, can be of course produced also by using a film including a substrate layer having the eye marks 115 and predetermined portions previously colored.

However, recently, there is a tendency to produce a wide variety of products in small quantities. Therefore, in the case of a production method using a substrate layer having eye marks and predetermined portions previously colored, it is difficult to change the position of each of the attaching sites 114 to which the product-enclosed bag 200 is attached or the color of the predetermined portions. Therefore, partial coloring of a substrate layer is preferably performed in a step of producing bags. A specific method is as follows.

First, a laminate film including a sealant layer, which has an outer layer including a low-melting-point polymer layer and an inner layer including an adhesive layer, and a substrate layer is prepared as a raw material of the display strip 100. The laminate film has eye marks previously printed at predetermined intervals, and is transparent in a region other than portions where the eye marks are printed.

By the time product-enclosed bags are attached by thermal compression bonding to the laminate film fed from a supply roll, printing is performed, under the control of the eye marks, on the laminate film only in predetermined regions within regions where the adhesive layer is exposed by detaching the product-enclosed bags or only in regions other than the predetermined regions, from the substrate layer side of the laminate film, that is, from the back side of the product assembly 300.

Then, the product-enclosed bags 200 are attached to a display strip 100 obtained using the laminate film having been subjected to the above step by thermal compression bonding at predetermined sites within the predetermined regions. A product assembly 300, in which the color of the substrate layer in a region including the attaching site 114 is different from that of the substrate layer at other sites, can be obtained through the above steps.

The product-enclosed bags 200 may be fusion-bonded to the display strip 100 by ultrasonic sealing or high-frequency sealing instead of heat sealing.

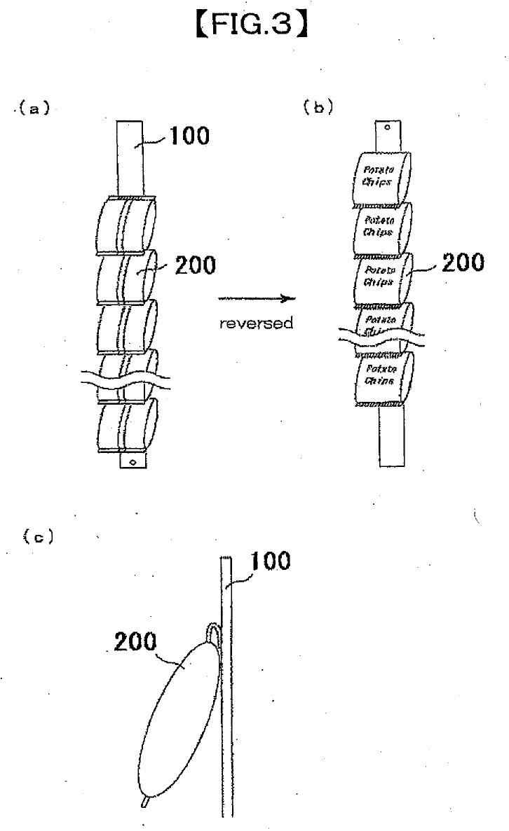

The method for producing a product assembly by fusion-bonding is not particularly limited, but for example, a process shown in FIG. 3 is preferably employed for attaching product-enclosed bags to a product assembly. According to this process, first, the product-enclosed bag 200 is placed so that the front side of the product-enclosed bag 200 comes into contact with the display strip 100. Then, the upper portion of a packaging film constituting the product-enclosed bag 200 is fusion-bonded to bond the packaging film to the display strip 100 (see FIG. 3a).

After a predetermined number of the product-enclosed bags 200 are attached to the display strip 100 by fusion bonding, the display strip 100 is vertically reversed to turn each of the product-enclosed bags 200 upside down around the attaching site of the product-enclosed bag 200 serving as an axis so that the front faces of the product-enclosed bags 200 face a direction opposite to the display strip 100 (see FIG. 3b). In such a state, the product assembly is displayed by suspending one end of the display strip 100 on a hook H and the like. In this case, each of the product-enclosed bags 200 is attached to the display strip 100 at the attaching site in such a mariner as shown in FIG. 3c. Therefore, by pulling each of the product-enclosed bags 200 downwardly, it can be detached from the product assembly in a region including the attaching site with only the sealant layer being attached to the product-enclosed bags 200 within the divided region.

The seal strength between the product-enclosed bag 200 and the display strip 100 of the product assembly according to the present invention is not particularly limited, but the lower limit thereof is preferably 1 N/30 mm, and the upper limit thereof is preferably 50 N/30 mm. If the seal strength is less than 1 N/30 mm, there is a case where a product falls under its own weight depending on the weight of the product. On the other hand, if the seal strength exceeds 50 N/30 mm, there is a case where the suspended product-enclosed bag is not detached even when it is pulled downward. The lower limit thereof is more preferably 5 N/30 mm, and the upper limit thereof is more preferably 30 N/30 mm.

The states of fusion bonding and peeling-off between the product-enclosed bag 200 and the display strip 100 may widely vary depending on the method or conditions of fusion bonding. When fusion bonding is performed by heat sealing, the conditions of fusion bonding may vary depending not, only on a temperature during fusion bonding, contact time of seal jaws, contact pressure, etc. but also on the shape of the seal jaws. Therefore, it is preferred that optimum sealing conditions are selected depending on the kind of a resin composition constituting the low-melting-point polymer layer 111 of the display strip 100 or on a material for the surface layer of the product-enclosed bag. The width of the seal jaw is selected depending on the desired length of a contact surface between the display strip 100 and the surface of the product-enclosed bag, and this length substantially defines the distance from the beginning of peeling-off to the end of the peeling-off when the product-enclosed bag is peeled off from the display strip 100.

1. A product assembly with product enclosed bags attached to a display strip,
wherein said display strip comprises a sealant layer and a substrate layer,
said sealant layer has an outer layer including a low-melting-point polymer layer, to which said product-enclosed bags are attachable by heat fusion, and an inner layer including an adhesive layer, to which said product-enclosed bags are reattachable,
said product-enclosed bags are attached to said display strip by thermal compression bonding at attaching sites,
said low-molting-point polymer layer is transparent and
a color of said adhesive layer at the attaching sites is different from that of said adhesive layer at other sites.

2. The product assembly according to claim 1, wherein the adhesive layer of said display strip contains at least one of a heat-sensitive ink and a pressure-sensitive ink, and wherein a color of said adhesive layer at said attaching sites is different from that of said adhesive layer at other sites due to a change of color of said ink contained in said adhesive layer at said attaching sites.

3. A product assembly with product-enclosed bags attached to a display strip,
wherein said display strip comprises a sealant layer and a substrate layer,
wherein said sealant layer has an outer layer including a low-melting-point polymer layer, to which said product-enclosed bags are attachable by heat fusion, and an inner layer including an adhesive layer, to which said product-enclosed bags are reattachable,
said product-enclosed bags are attached to said display strip by thermal compression bonding at attaching sites,
said low-melting-point polymer layer and said adhesive layer are both transparent, and
a color of said substrate layer in a region including at least said attaching site, within regions where said adhesive layer is exposed by detaching said product-enclosed bags, is different from that of said substrate layer at other sites.

4. A method for producing the product assembly according to claim 3,
in which a color of a substrate layer in a region including attaching sites is different from that of said substrate layer at other sites,
the method comprising steps of:
by using a laminate film, which includes an sealant layer, having an outer layer including a low-melting-point polymer layer and an inner layer including an adhesive layer, and the substrate layer, and which has eye marks previously printed at predetermined intervals, and which is transparent in a region other than portions where said eye marks are printed,
performing printing on said laminate film, fed from a supply roll, from said substrate layer side of said laminate film only in predetermined regions within regions where said adhesive layer is exposed by detaching product-enclosed bags or only in regions other than said predetermined regions under the control of said eye marks by the time said product-enclosed bags are attached by thermal compression bonding to said laminate film; and
attaching said product-enclosed bags to a display strip, obtained using said laminate film through said step, by thermal compression bonding at predetermined sites within said predetermined regions.
